(19) United States
(12) Patent Application Publication
(10) Pub. No.: US 2004/0032664 A1
(43) Pub. Date: Feb. 19, 2004

(54) Color-corrected collimating lens

(76) Inventors: Jack V. Miller, Seaford, DE (US); Ruth E. Miller, Seaford, DE (US)

Correspondence Address: JACK V. MILLER, 20915 Sussex Highway 13, Seaford, DE, 19973, US

(21) Appl. No.: 10/223,094

(22) Filed: Aug. 19, 2002

(51) Int. Cl. G02B 27/10

(52) U.S. Cl. 359/619; 359/634; 359/599

(57) ABSTRACT

A lens according to the present invention comprises a macro lens having radial light refraction varying from zero on the optical axis to a maximum refraction angle at the lens rim. A pattern of light-diffusing micro lenses, on at least one macro lens surface, vary in radial light-diffusion angle in proportion to the angle of refraction of the macro lens. In a second preferred embodiment the macro lens has light-diffusing micro lenses in the form of concentric, linear-lens rings about the optical axis, whereby the diffusion angle of each micro lens is radial only and is equal to the included angle of the radial chromatic aberration angle of the macro lens at the same point on the macro lens.

the heat of most light sources will causes the lens bonding to fail in use. Thus, bonded color-correction lenses have proven unsatisfactory in collimating light fixtures, leaving a long-felt need for color-corrected collimating lenses that are reliable and economical for use in narrow-beam lighting fixtures.

One method of reducing chromatic aberration is shown in the applicant's prior-art U.S. Pat. No. 5,268,977. This patent shows a relatively large macro lens with at least one surface covered with an overall pattern of small, substantially-uniform, lenticular micro lenses. The purpose of the micro lenses is to increase the depth of field of the collimating lens, so it can be zoomed without producing a dark hole at any zoom position. However, it was found that the micro lenses also diffuse the aberration so the colors that would otherwise be refractively separated into color band aberrations were also diffused, causing the diverging color bands to be superimposed back into white light.

The disadvantage of the pattern of micro lenses of the '977 patent is that it created more diffusion than was needed to correct the aberration. Although a small amount of diffusion was desired to soften the projected light beams, the micro lens pattern made the macro lens beam wider than necessary.

### OBJECTS OF THE INVENTION

The primary object of the present invention is to provide a collimating lens that has no chromatic aberrations without excessive beam enlargement or edge diffusion. Another object of the invention is to provide an inexpensive aberration-free lens that can be molded as a single piece of transparent material, such as plastic or glass. Yet another object of the invention is to provide an aberration-free lens that may be zoomed in beam angle with uniform intensity across the beam. Yet another object of the invention is to provide an aberration-free lens that projects a smooth, soft-edged beam without unnecessary diffusion.

### DESCRIPTION AND ADVANTAGES OF THE INVENTION

A lens according to a first preferred embodiment of the present invention comprises a one-piece macro lens having a variable light refraction from zero on the optical axis to a maximum refraction at the lens edges, and including light-diffusing lenticular micro lenses also variable from zero diffusion on the optical axis to a maximum diffusion at the lens edges.

In a second preferred embodiment of the present invention the macro lens has micro lenses in the form of circular, concentric, linear-lens rings about the optical axis, wherein the radial diffusion angle of each micro lens is equal to the included angle of radial chromatic aberration of the macro lens. The principle advantage of a lens according to the second preferred embodiment is that there is no optical diffusion where there is no refraction or no chromatic aberration, thereby providing a smaller beam with no aberration.

The principle of a lens of the second preferred embodiment is that chromatic aberration of a circular lens is always radial. The macro lens is circular and produces radial refraction and hence only radial chromatic aberration. There is no tangential refraction perpendicular to the radials, and thus there are no tangential aberrations. Therefore there is no need for tangential diffusion. The concentric rings micro lenses of the second preferred embodiment provide no tangential diffusion where the macro lens produces no tangential aberration. This embodiment thus provides minimum possible diffusion, with a smaller beam focus than either the applicant's prior-art U.S. Pat. No. 5,268,977 or the first preferred embodiment of the present invention.

### BRIEF DESCRIPTION OF THE DRAWINGS

FIG. 1 is a cross section of a prism showing color refraction angles;

FIG. 2 is a cross section of a lens showing color aberration angles;

FIG. 3 is a cross-sectional ray-trace diagram of a prior-art collimating lens showing the source of chromatic aberration in applicant's U.S. Pat. No. 5,268,977;

FIG. 4 is a cross-sectional ray-trace diagram of a lens according to the present invention showing reduced chromatic aberration;

FIG. 5 is a cross-sectional view of a Fresnel macro lens according to the present invention, showing the correction of chromatic aberration with graduated micro lens diffusion;

FIG. 6 is a plan view of the diffusion surface of the lens of FIG. 5 in which the diffusion micro lenses are lenticular lenses of progressively varying diffusion angles;

FIG. 7 is a plan view of the macro lens surface of the Fresnel macro lens of FIG. 5, in which the Fresnel lens rings progressively varying refraction angles;

FIG. 8 is a cross-sectional view of a lenticular macro lens according to the present invention, showing the correction of chromatic aberration with graduated micro lens diffusion; and

FIG. 9 is a plan view of a lenticular macro lens of FIG. 4 or 8, according to the present invention, showing the correction of chromatic aberration with graduated diffusion using concentric rings of micro lenses having lenticular cross sections;

REFERENCE NUMERALS IN DRAWINGS

1. prior-art luminaire
2. light source
3. housing
4. prior-art lens
5. macro lens surface
6. micro lenses
7. macro lens edges
8. lens center area
9. diffusion angles
10. not used
11. luniinare
12. light source
13. housing
14. present invention lens
15. macro lens edges
16. edge micro lenses
17. transition micro lenses
18. macro lens central area
19. maximum diffusion
20. zero diffusion
21. not used
22. central micro lens area
23. not used
24. present invention Fresnel lens
25. macro lens edges
26. reduced diffusion micro lenses
27. transition micro lenses
28. reduced power micro lenses
29. minimum power micro lenses
30. central micro lens area
31. maximum refraction ring
32. reduced refraction ring
33. more reduced refraction ring
34. central macro lens area
35. not used
36. not used
OA optical axis
Fp focal plane
R red light aberration
G green light aberration
B blue light aberration

### DETAILED DESCRIPTION OF THE DRAWINGS

In FIG. 1 a prism is shown having a beam of white light W entering the prism and being refracted into separate colors shown as Red, Green and Blue bands.

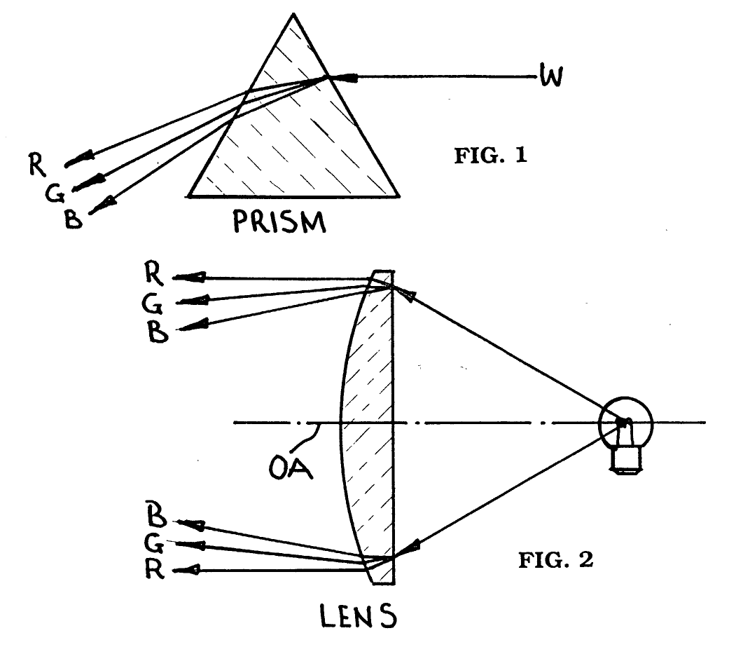

In FIG. 2 a lens is shown also having white light from a light source, separated by refraction into colors shown as Red, Green and Blue bands. These color bands are formed by the edges of the lens, as if a prism was formed into a circle. Thus the color bands form concentric rings as chromatic aberrations around the edges of a projected light beam.

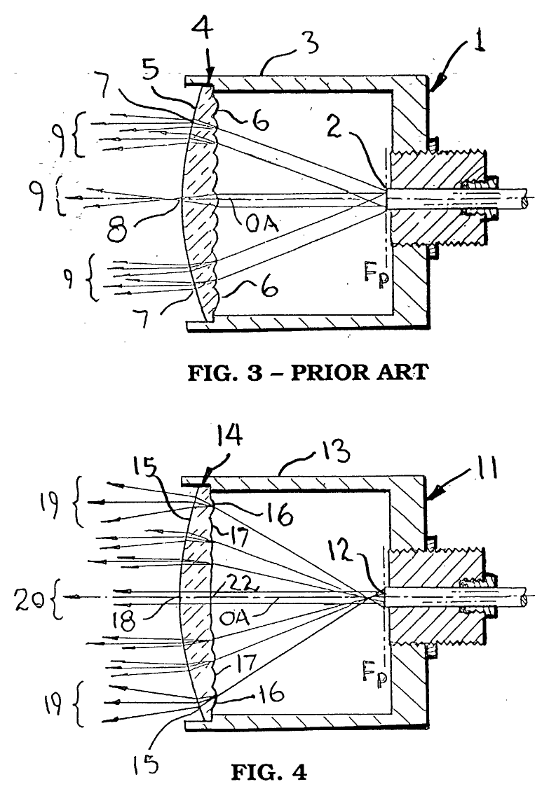

In FIG. 3 a prior-art luminaire 1 is shown having an optical axis OA in a luminaire housing 3, having a focal plane Fₚ for lens 4. Lens 4 has a macro lens surface 5 having refracting edges 7 and a non-refracting central area 8. A light source 2, shown as an optical fiber, is positioned on the optical axis OA on focal plane Fₚ. Light source 2 produces light rays in a diverging cone of light that intercepted by lens 4. Light rays are refracted through lens 4 at the lens edges 7 to emerge as substantially collimated light. Diffusion micro lenses 6 provide controlled diffusion angles 9 of otherwise collimated as described in the applicant's U.S. Pat. No. 5,268,977. Fiber optic luminaires of this design have been successfully sold and used for many years, providing aberration-free light beams capable of 10:1 zoom ratios with smooth, even light without chromatic aberrations.

In FIG. 4 a luminaire 11 has a lens 14 according to the present invention shown in a luminaire housing 13. A light source 12 is positioned on the optical axis OA in focal plane FP. The inventors hereof recognized that the prior-art lens design of FIG. 3 could be significantly improved by making the diffusing micro lenses graduated in power from the lens center to the lens edges. Similar to the luminaire of FIG. 3, the light source 12 of FIG. 4 produces light rays in a diverging cone of light that are intercepted by lens 14. Light rays are refracted through lens edge areas 15 to emerge as substantially collimated light. Diffusion micro lenses 16 provide the greatest diffusion of the otherwise collimated light near macro lens edges 15, and wherein micro lenses 17 provide transitional diffusion at reduced power to just eliminate chromatic aberration in the projected beam. However, the chromatic aberration angle is proportional to the light refraction angle. Where there is no refraction there is no aberration, so there is no need to diffuse the light passing through the relatively flat central lens area 18. Thus light emerges as collimated rays 20 from lens area 18, with no significant diffusion on the central area 22 of lens 14. Diffusion micro lenses provide a transitionally controlled diffusion by micro lenses from zero or slight diffusion in the central area 22 through increasing diffusion micro lenses 17 to maximum diffusion micro lenses 16, whereby the diffusion at each lens radius is just enough to blend chromatic aberration colors back into the projected beam as white light that supplements the usable beam instead of detracting from beam quality.

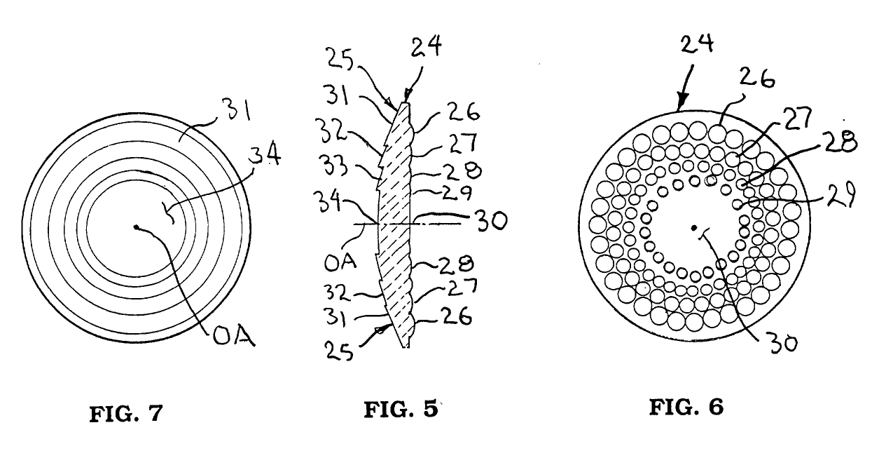

In FIG. 5 a cross-sectional view of a Fresnel macro lens collimating lens 24 according to the present invention is shown, in which the correction of chromatic aberration with graduated-diffusion lenticular micro lenses 26 through 29 have progressively lower power from the maximum in micro lenses 26, through reduced power of 27, 28, and 29 to zero or near-zero power in the central macro lens area around the optical axis OA, wherein the macro lens 24 is substantially flat in central area 34.

In order to provide high optical efficiencies, spotlights usually have the largest practical aperture diameters; often as large as f:1, where the lens diameter is equal to the focal length. However, this requires the lens surfaces to have macro lens refraction angles as large as 45° at the edges, which in turn, produces aberrations in a band around the projected beam edges of approximately 6% of the beam diameter from a point light source. Thus a 36-inch diameter beam can have a ring of chromatic aberration over an inch wide and a 6-foot-diameter theatrical spot beam would have aberration an ring over 2 inches wide.

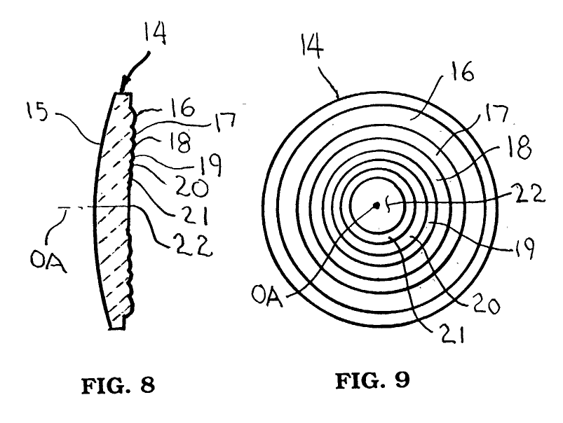

To re-converge the chromatic aberration colors into white light, it s necessary to diffuse the light by 3% of the refraction angle, or approximately 1.3° at the edges of the lens. However, the diffusion needed for the aberration correction remains 3% of the refraction angle that progressively diminishes to zero at the optical axis at the macro lens center. Therefore the required diffusion varies proportionally with the refraction angle, from approximately 1.3° at the lens edges to zero or near zero at the center. This configuration re-distributes the otherwise distracting-chromatic aberrations over the projected beam area, increasing the optical efficiency of the lens. The macro lens configuration does not affect the required aberration-correction diffusion angle, so the Fresnel design shown in FIG. 5 requires exactly the same diffusion as a lenticular macro lens configuration shown in FIG. 4 or 8.

In FIG. 6 a plan view of the diffusion surface of the lens of FIG. 5 in which the diffusion micro lenses are lenticular lenses of progressively varying diffusion angles, with the largest diffusion angle micro lenses 26 around the edges of lens 24, diminishing in diffusion power through micro lenses 27 through 29, towards the lens center area 30. In the interest of simplicity the micro lens pattern is shown in only 4 steps, but in practice the entire diffusion surface is graduated from a maximum at the macro lens edges to zero at the macro lens center.

In FIG. 7 a plan view of the Fresnel macro lens surface 25 of macro lens 24 of FIG. 5 is shown, in which the Fresnel lens rings 31 through 34 progressively vary refraction angles to near zero in the central lens area and to zero at the optical axis OA.

In FIG. 8 a cross-sectional view of a lenticular macro lens 14 of FIGS. 4 and 8, shows the correction of chromatic aberration with graduated circularly-linear, lenticular-cross-section micro lenses 16 through 21 of diminishing diffusion to zero or near zero at central area 22 near the optical axis OA.

In FIG. 9 a plan view of a lenticular collimating macro lens 14 according to the present invention, shows the correction of chromatic aberration with graduated diffusion micro lenses 16 having peak power at the macro lens edges. The power of successive rings 17 through 21 diminish through 22 diminish to zero or near zero at the optical axis OA. The concentric rings of micro lenses have lenticular cross sections. The macro lens refractions, and therefore aberrations, are produced only in radial directions at any point on the lens. With no tangential macro lens angles, and thus no refractions at all in the tangential directions, there are no aberrations to correct. The concentric, circular micro lens design thus provides a light beam of sharper focus, but still with no chromatic aberration ring around the beam edges.

### OPERATION OF THE INVENTION

In operation lenses according to the invention produce tighter, more sharply-focussed beam patterns with no chromatic aberration rings. This represents a dramatic improvement over existing collimating lenses without aberration diffusion, and a significant improvement over lenses made under the applicants '977 patent.

### SUMMARY, RAMIFICATIONS AND SCOPE

The primary object of the present invention has been achieved and provides a collimating lenses that has no chromatic aberrations without excessive beam enlargement or edge diffusion. Another benefit of the invention is volume production of inexpensive, aberration-free lenses that can be molded as a single piece of transparent material, such as plastic or glass. Yet another object achieved by the invention is an aberration-free lens that may be zoomed in beam angle with uniform intensity across the beam.

In a first preferred embodiment of the invention the lens has micro lenses with omnidirectional diffusion angles, in which each diffusion angle is equal to the included angle of chromatic aberration a each radial position from the optical axis to the lens edges. The principle advantage of a lens according to this first preferred embodiment, is that there is no optical diffusion where there is no chromatic aberration, thereby providing a tighter beam focus than the applicant's prior-art '977 patent which has overall, uniform diffusion from microscopic, lenticular micro lenses.

In a second preferred embodiment of the invention the lens has lenticular cross-section micro lenses in the form of concentric, linear rings about the optical axis. The principle advantage of a lens of the second preferred embodiment of the invention is that chromatic aberration of a macro lens is always radial, with no diffusion at transverse tangential angles. Thus the diffusion angle of the micro lenses is radial only and equal to the included angle of radial chromatic aberration from the optical axis to the lens edges, but with no tangential diffusion. Therefore the second embodiment of the invention provides a still smaller beam focus than either the Applicant's prior-art U.S. Pat. No. 5,268,977 or the first preferred embodiment of the present invention.

The scope of applications for the present invention includes lenses used for exhibit lights, merchandise spotlights, medical lights, entertainment spotlights, framing projectors and special-effects projectors that project patterns having sharp definition without aberrations.

1. A color-corrected lens including:
a macro lens having light refraction varying from zero on an optical axis to a maximum refraction at the lens edges, and including a pattern of light-diffusing micro lenses having diffusion angles varying from zero on the optical axis to a maximum diffusion at the lens edges.

2. A color-corrected lens according to claim 1 in which:
the macro lens is a single transparent lens element with chromatic aberration angles radially varying from zero on the optical axis to a maximum angle at the lens edges; and the light-diffusing micro lenses have diffusion angles matching the macro lens aberration included angles varying from zero on the optical axis to a maximum diffusion angle at the lens edges.

3. A color-corrected lens according to claim 1 in which micro lenses are radially-spaced and have light-diffusion angles varying in proportion to the refraction angle of the macro lens in visible light wavelengths between 380 and 770 nanometers.

4. A color-corrected lens according to claim 1 in which the pattern of light-diffusing micro lenses is a pattern of adjacent, contiguous lenticular lenses covering substantially all of at least one macro lens surface.

5. A color-corrected lens according to claim 1 in which the pattern of light-diffusing micro lenses is a pattern of concentric, circular, linear lenses, having substantially lenticular cross sections on at least one macro lens surface.
